(19) United States
(12) Patent Application Publication
(10) Pub. No.: US 2026/0103871 A1
(43) Pub. Date: Apr. 16, 2026

(54) SWING DECELERATION CONTROL SYSTEM

(71) Applicant: Deere & Company, Moline, IL (US)

(72) Inventors: Piyush D. Ainapure, Pune (IN); Lance R. Sherlock, Asbury, IA (US); Matthew J. Ramler, Luxemburg, IA (US); Nitin S. Dhanke, Pune (IN)

(21) Appl. No.: 18/911,664

(22) Filed: Oct. 10, 2024

(51) Int. Cl. E02F 9/12; E02F 3/32; E02F 9/20; F15B 13/04

(52) U.S. Cl. CPC E02F 9/123; E02F 3/32; E02F 9/2004; F15B 13/04

(57) ABSTRACT

A working machine includes an undercarriage, a main frame, and a hydraulic motor to pivot the main frame. A boom assembly extends from the main frame. An operator input actuator directs pivotal movement of the main frame about the pivot axis relative to the undercarriage. A motion detection sensor detects the pivotal movement of the main frame and boom assembly. An adjustable control valve is communicated with first and second pressure ports of the swing hydraulic motor. A controller receives an operator input signal from a joystick directing the pivotal movement and a swinging motion signal from the motion detection sensor. The controller detects an inertia caused pivotal motion of the main frame and boom assembly relative to the undercarriage continuing after the operator input actuator is moved to the neutral position and sends a command signal to the adjustable control valve to reduce the inertia caused pivotal motion.

### FIELD OF THE DISCLOSURE

The present disclosure relates to working machines of the type having a boom assembly pivotal about a generally vertical pivot axis relative to an undercarriage of the working machine.

### BACKGROUND

Working machines of this type may for example include excavator machines, feller buncher machines, front shovel machines, and others. These machines may have tracked or wheeled ground engaging units supporting the undercarriage from the ground surface. Such machines include a boom assembly pivotal about a generally vertical pivot axis relative to an undercarriage of the working machine during the “swinging” of the boom assembly. One issue faced in the operation of such machines is the phenomena of “swing wag” due to the inertia of the moving main frame and boom assembly when the swinging action is stopped.

When the joystick or other actuator is returned to a neutral position to stop the swinging motion, the kinetic energy of the swinging body including the main frame and the boom assembly is stored in a compression of the oil in the hydraulic system which is then released causing the swinging body to swing back in the opposite direction. The current technology for dealing with “swing wag” is the use of an anti-reaction valve which mechanically opens a passage between the high and low pressure lines of the hydraulic motor driving the swinging action. The anti-reaction valve is essentially a mechanical pressure relief valve which releases the potential energy stored in the compression of the oil in the hydraulic system, thus reducing the “swing wag.” Such anti-reaction valves do not work accurately over all deceleration profiles due to their fixed pressure relief settings and fixed orifice sizes.

There is a need for improved systems for dealing with “swing wag.”

### SUMMARY OF THE DISCLOSURE

The current disclosure provides improved control systems for controlling the deceleration of the swinging body including the boom assembly, so as to reduce the problem of “swing wag.”

In one embodiment a working machine includes an undercarriage including a plurality of ground engaging units for engaging a ground surface. A main frame is supported from the undercarriage such that the main frame is pivotable about a pivot axis relative to the undercarriage. A swing hydraulic motor is configured to pivot the main frame about the pivot axis relative to the undercarriage, the swing hydraulic motor including first and second pressure ports for receiving and discharging hydraulic fluid driving the swing hydraulic motor. A boom assembly extends from the main frame. An operator input actuator generates an operator input signal directing pivotal movement of the main frame and boom assembly about the pivot axis relative to the undercarriage, the operator input actuator having a neutral position. A motion detection sensor is provided for detecting pivotal movement of the main frame and boom assembly about the pivot axis relative to the undercarriage and for generating a swinging motion signal representative of the pivotal movement of the main frame and boom assembly about the pivot axis relative to the undercarriage. An adjustable control valve is communicated with the first and second pressure ports of the swing hydraulic motor. A controller is operably connected to the operator input actuator to receive the operator input signal and the controller is operably connected to the motion detection sensor to receive the swinging motion signal. The controller is configured to: detect an inertia caused pivotal motion of the main frame and boom assembly relative to the undercarriage continuing after the operator input actuator is moved to the neutral position; and send a command signal to the adjustable control valve to reduce the inertia caused pivotal motion.

In another embodiment a method is provided of operating a working machine, the working machine including an undercarriage including a plurality of ground engaging units for engaging a ground surface, a main frame, a swing hydraulic motor configured to pivot the main frame about a pivot axis relative to the undercarriage, a boom assembly extending from the main frame, an operator input actuator for generating an operator input signal directing pivotal movement of the main frame and boom assembly about the pivot axis relative to the undercarriage, and an adjustable control valve communicated with first and second pressure ports of the swing hydraulic motor. The method includes: detecting with a motion detection sensor a pivotal movement of the main frame and boom assembly about the pivot axis relative to the undercarriage and generating with the motion detection sensor a swinging motion signal representative of the pivotal movement of the main frame and boom assembly about the pivot axis relative to the undercarriage; receiving the operator input signal and the swinging motion signal with an automatic controller; detecting with the automatic controller an inertia caused pivotal motion of the main frame and boom assembly relative to the undercarriage continuing after the operator input actuator is moved to a neutral position; and sending a command signal from the automatic controller to the adjustable control valve to reduce the inertia caused pivotal motion.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side elevation view of a tracked excavator machine incorporating the automatic control systems disclosed herein.

FIG. 2 is a schematic rear elevation exploded view of the tracked excavator machine of FIG. 1 illustrating the undercarriage separated from the swing bearing and the main frame.

FIG. 3 is a schematic plan view of the excavator with the operator’s cabin removed, schematically showing the location of an IMU on the main frame and of a rotary sensor for detecting rotation of the main frame and boom assembly relative to the undercarriage.

FIG. 4 is a schematic side elevation view of a portion of the boom assembly schematically showing the location of a boom IMU.

FIG. 5 is a graph depicting pressures in the hydraulic system of the swing motor of the excavator as a function of time.

FIG. 6 is a hydraulic schematic showing a first embodiment of a swing deceleration control system.

FIG. 7 is a hydraulic schematic showing a second embodiment of a swing deceleration control system.

FIG. 8 is a schematic drawing of a controller of the excavator, and various sensors and actuators operably associated with the controller.

FIG. 9 is a flow chart depicting one method of implementing the swing deceleration control system.

FIG. 10 schematically illustrates the joy stick pattern for the left hand joystick of an excavator using an SAE pattern for control of the swing operation.

### DETAILED DESCRIPTION

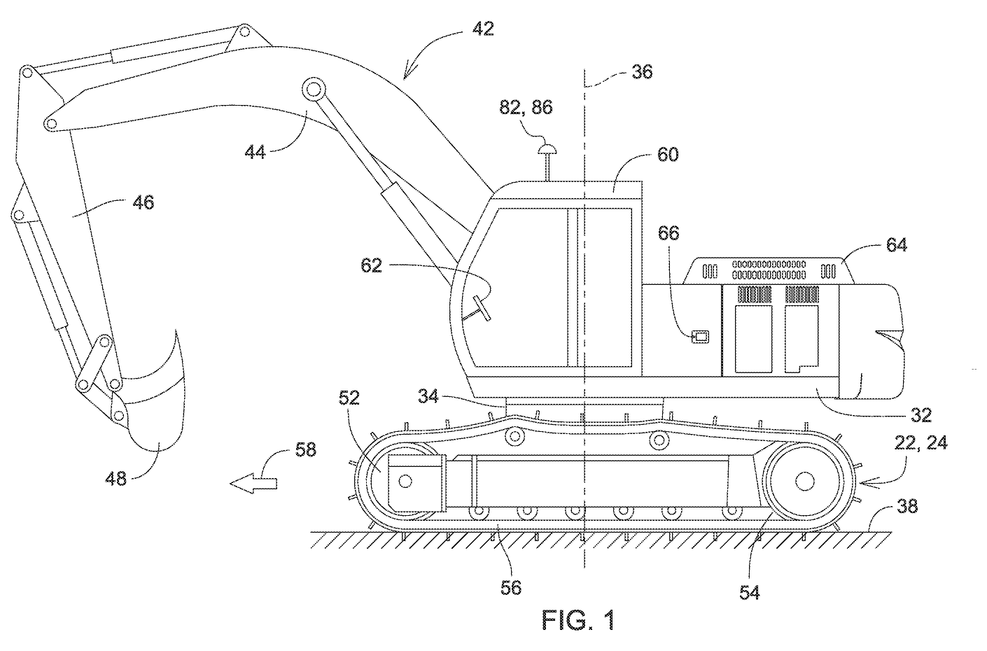

Referring now to the drawings and particularly to FIG. 1, a working machine is shown and generally designated by the number 20. FIG. 1 shows a tracked excavator machine 20. The systems disclosed herein are applicable to excavator machines, feller buncher machines, front shovel machines, and other working machines of the type having a boom assembly pivotal about a generally vertical pivot axis relative to an undercarriage of the working machine. These machines may have tracked or wheeled ground engaging units supporting the undercarriage from the ground surface.

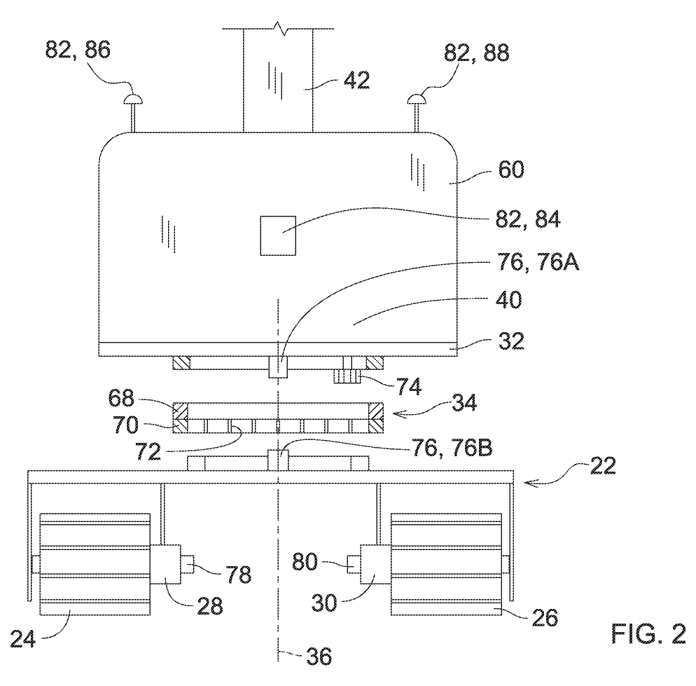

The working machine 20 is shown in side elevation assembled view in FIG. 1, and in rear elevation schematic partially exploded view in FIG. 2.

The working machine 20 includes an undercarriage 22 including first and second ground engaging units 24 and 26 including first and second travel motors 28 and 30 for driving the first and second ground engaging units 24 and 26, respectively.

A main frame 32 is supported from the undercarriage 22 by a swing bearing 34 such that the main frame 32 is pivotable about a pivot axis 36 relative to the undercarriage. The pivot axis 36 is substantially vertical when a ground surface 38 engaged by the ground engaging units 24 and 26 is substantially horizontal. A swing hydraulic motor 40 is configured to pivot the main frame 32 on the swing bearing 34 about the pivot axis 36 relative to the undercarriage 22. The swing hydraulic motor 40 may also be referred to herein as simply a swing motor 40 or hydraulic motor 40.

A boom assembly 42 includes a boom 44, an arm 46 pivotally connected to the boom 44, and a working tool 48. The boom 44 is pivotally attached to the main frame 32 to pivot about a generally horizontal axis relative to the main frame 32. The working tool in this embodiment is an excavator shovel 48 which is pivotally connected to the arm 46. The boom assembly 42 extends from the main frame 32 along a working direction 50 of the boom assembly 42. The working direction 50 can also be described as a working direction of the boom 44.

In the embodiment of FIG. 1 the first and second ground engaging units 24 and 26 are tracked ground engaging units. Each of the tracked ground engaging units includes a front idler 52, a drive sprocket 54, and a track chain 56 extending around the front idler 52 and the drive sprocket 54. The travel motor 28 or 30 of each tracked ground engaging unit 24 or 26 drives its respective drive sprocket 54. Each tracked ground engaging unit has a forward traveling direction 58 defined from the drive sprocket 54 toward the front idler 52. The forward traveling direction 58 of the tracked ground engaging units also defines a forward traveling direction 58 of the undercarriage 22 and thus of the working machine 20.

An operator’s cab 60 may be located on the main frame 32. The operator’s cab 60 and the boom assembly 42 may both be mounted on the main frame so that the operator’s cab 60 faces in the working direction 50 of the boom assembly. A control station 62 may be located in the operator’s cab 60.

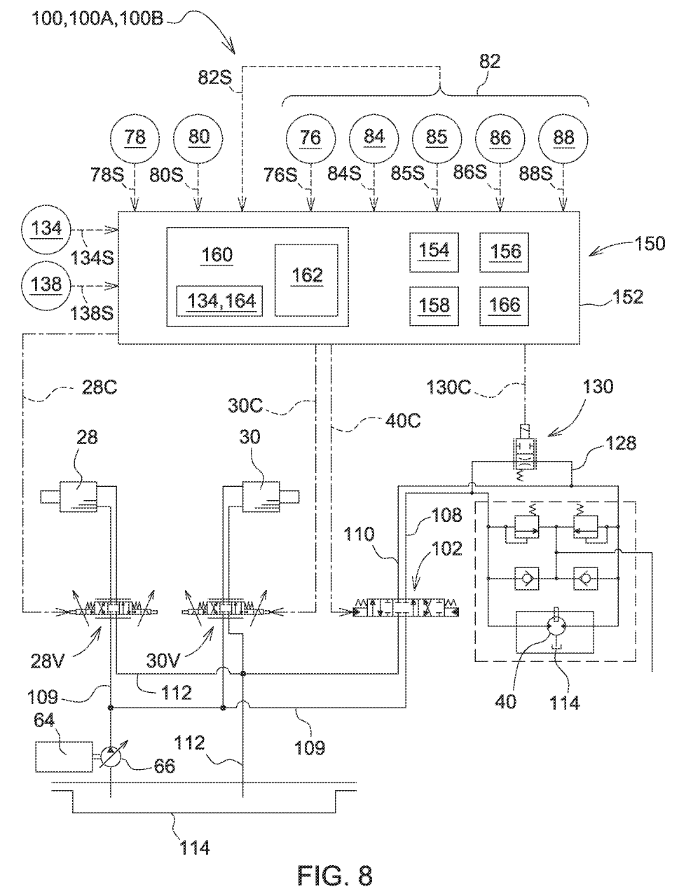

Also mounted on the main frame 32 is an engine 64 for powering the working machine 20. The engine 64 may be a diesel internal combustion engine. The engine 64 may also be any other suitable prime mover, including an electric motor. The engine 64 may drive a hydraulic pump 66 to provide hydraulic power to the various operating systems of the working machine 20. The engine 64, the hydraulic pump 66 and the related hydraulic power system for the working machine 20 are further illustrated schematically in FIG. 8 which is further described below.

The swing bearing 34 as schematically shown in FIG. 2 includes an upper ring 68 configured to be bolted to the underside of the main frame 32, and a lower ring 70 configured to be bolted to the undercarriage 22. The lower ring 70 includes an internally toothed ring gear 72. The swing motor 40 is mounted on the main frame 32 and drives a pinion gear 74 which extends downward into engagement with the internally toothed ring gear 72. Operation of the swing motor 40 drives the pinion gear 74 which results in pivoting movement of the main frame 32 on the swing bearing 34 about the pivot axis 36 relative to the undercarriage 22.

As schematically illustrated in FIG. 2, a pivot angle sensor 76 may include an upper sensor part 76A mounted on the main frame 32 and a lower sensor part 76B mounted on the undercarriage 22. The pivot angle sensor 76 is configured to provide a pivot angle signal 76S (see FIG. 8) corresponding to a pivot position of the main frame 32 relative to the undercarriage 22 about the pivot axis 36. The pivot angle sensor 76 may for example be a Hall Effect rotational sensor. Such a Hall Effect rotational sensor may include a Hall element, a rotating shaft and a magnet. When the angular position of the Hall element changes, the corresponding changes in the magnetic field result in a linear change in output voltage. Other suitable types of rotary position sensors include rotary potentiometers, resolvers, optical encoders, inductive sensors and the like.

The first and second travel motors 28 and 30 may have associated therewith first and second travel motor speed sensors 78 and 80 configured to provide first and second travel motor speed signals 78S and 80S (see FIG. 8), respectively, corresponding to rotational speeds of the first and second travel motors 28 and 30. The travel motor speed sensors 78 and 80 may for example be Hall Effect rotational sensors, or any of the alternative sensor types noted above.

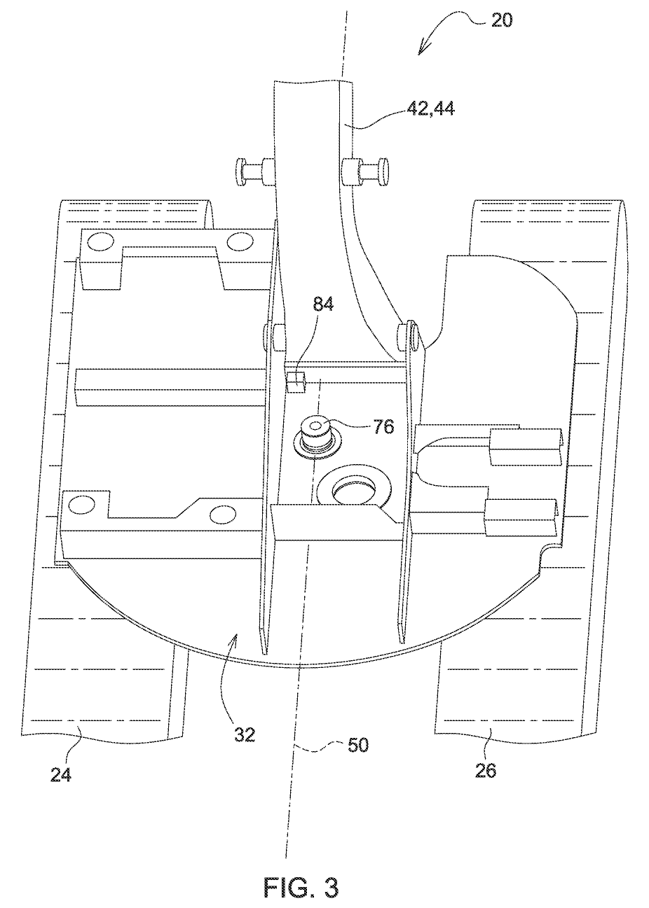

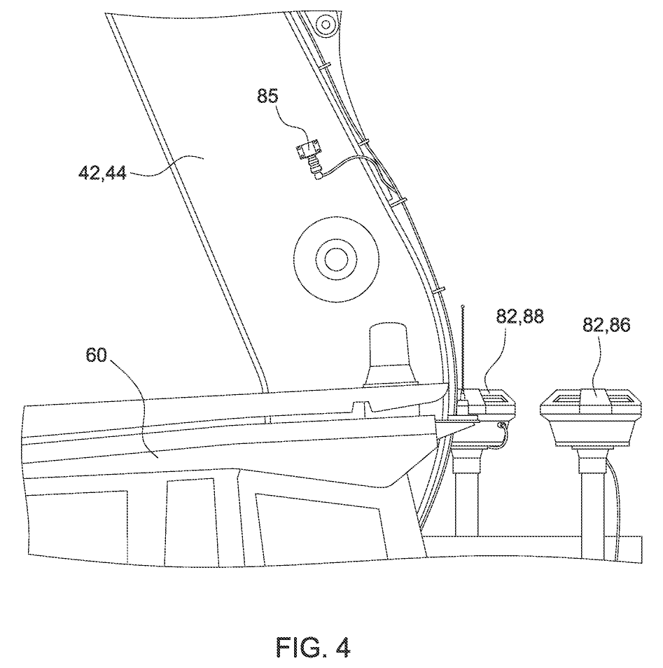

The working machine 20 may further include one or more motion detection sensors 82 configured to provide a swinging motion signal 82S (see FIG. 8) representative of the pivotal movement of the main frame 32 and the boom assembly 42 about the pivot axis 36 relative to the undercarriage 22. The motion detection sensors 82 may include the pivot angle sensor 76 previously described. The motion detection sensors 82 may include an inertial measurement unit (IMU) 84 mounted on the main frame 32 as seen in FIG. 3. The motion detection sensors 82 may include an inertial measurement unit (IMU) 85 mounted on the boom assembly 42 as seen in FIG. 4.

Those motion detection sensors in the form of an IMU may be in the form of a three-axis gyroscopic unit configured to detect changes in orientation of the orientation sensor 82, and thus of the main frame 32 or boom assembly 42 to which it is fixed, relative to an initial orientation.

Another embodiment of the motion detection sensor 82 may include a plurality of GPS sensing units 86, 88 fixed relative to the main frame 32 and the cab 60. Such GPS sensing units can detect the absolute position and orientation of the working machine 20 within an external reference system, and can detect changes in such position and orientation.

Another embodiment of the motion detection sensor 82 may include a camera based system which can observe surrounding structural features via image processing, and can respond to the orientation of the working machine relative to those surrounding structural features. Such a camera based orientation sensor 82 may also display to the human operator an image of the undercarriage and the surrounding ground surface 38.

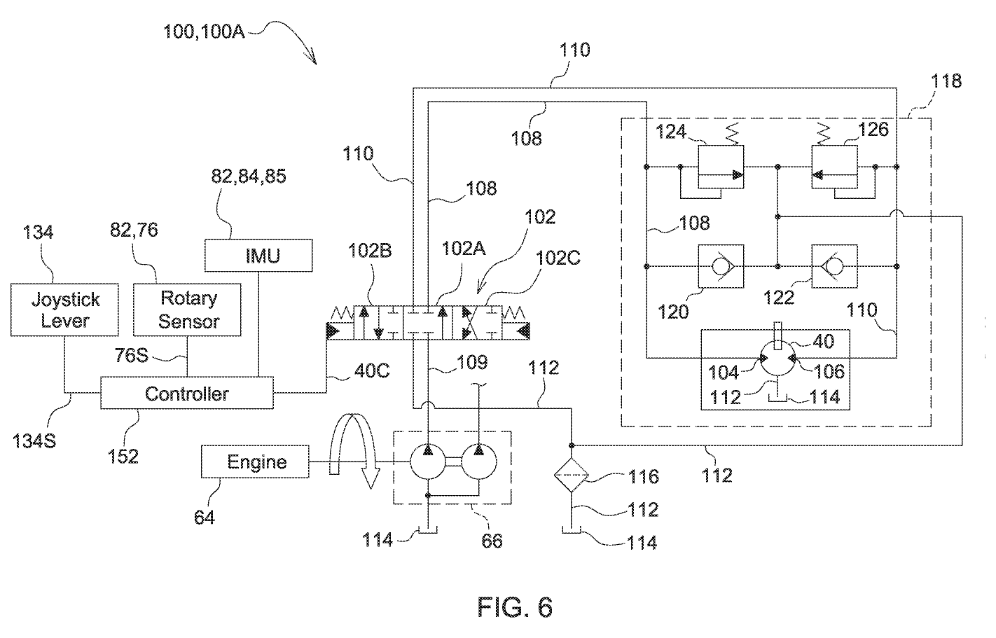

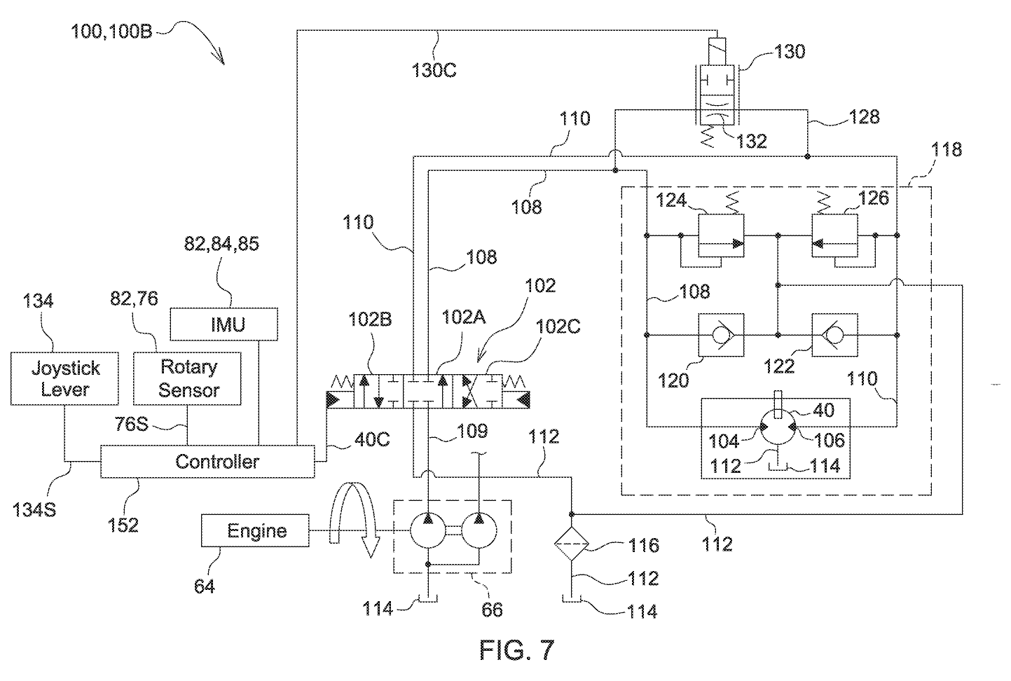

Two embodiments of a hydraulic control system 100 are shown in FIGS. 6 and 7 and further designated as 100A and 100B, respectively. FIG. 6 schematically illustrates a first embodiment of a hydraulic control system 100A configured to implement the swing deceleration control system of the present disclosure. As previously mentioned, the engine 64 drives the hydraulic pump 66 for supplying pressurized hydraulic fluid to the swing hydraulic motor 40. An electro-hydraulic directional control valve 102 is arranged to receive the pressurized hydraulic fluid from the hydraulic pump 66 via a supply line 109 and to control a flow direction and flow rate of the pressurized hydraulic fluid to a selected one of first and second pressure ports 104 and 106 of the swing hydraulic motor 40. In the common terminology of hydraulic pumps the first and second pressure ports 104 and 106 are often referred to as A and B ports.

First and second fluid supply lines 108 and 110 connect the electro-hydraulic directional control valve 102 to the first and second pressure ports, 104 and 106, respectively.

As schematically shown in FIG. 6 the electro-hydraulic directional control valve 102 is a three position valve including a first “closed” or “off” position 102A in which there is no communication between the hydraulic pump 66 and the hydraulic motor 40. As is further described below in connection with the control system of FIG. 8, the electro-hydraulic directional control valve 102 may also be referred to as an adjustable control valve 102 communicated with the first and second pressure ports 104 and 106 of the swing hydraulic motor 40.

In a second position 102B the outlet of pump 66 is communicated with the first fluid supply line 108 and thus with the first pressure port 104 to drive the hydraulic motor 40 in a first rotational direction, with spent hydraulic fluid exiting the second pressure port 106 being communicated via second supply line 110 and a low pressure return line 112 to a tank or reservoir 114. A filter 116 is shown in the low pressure return line 112. The pump 66 may take its hydraulic fluid from the tank 114.

In a third position 102C the outlet of pump 66 is communicated with the second fluid supply line 110 and thus with the second pressure port 106 to drive the hydraulic motor 40 in a second rotational direction, with spent hydraulic fluid exiting the first pressure port 104 being communicated via first supply line 108 and the low pressure return line 112 to the tank or reservoir 114.

Within the dashed border identified as 118 the drive motor 40 is shown with associated first and second check valves 120 and 122, and first and second pressure relief valves 124 and 126, communicated together in conventional manner to prevent over pressuring of the drive motor 40.

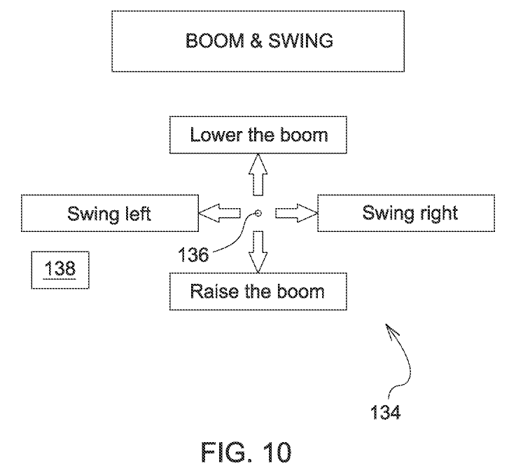

As is also schematically shown in FIG. 6, the electro-hydraulic directional control valve 102 is operably connected to the controller 152 described below, for receipt of control commands. And the controller 152 is operably connected to the various sensors described above and also to an operator input actuator 134 which may be in the form of a joystick. As will be understood by those skilled in the art a typical working machine of the type described herein, for example an excavator, will typically have two joystick controls 134. There is a left hand joystick and a right hand joystick. In an excavator, using SAE standard joystick patterns, the left hand joystick will control the boom swinging operation by moving the left hand joystick 134 to the left or right, and it will control the boom lower/raise function by moving the left hand joystick forward or backwards. Movement of the joystick 134 to direct a swinging motion will generate an operator input signal 134S which is sent to the controller 152 (see FIG. 8). FIG. 10 schematically illustrates such a joystick pattern for the actuator 134. The joystick 134 will be spring biased toward a neutral position 136 in which there is no operator input signal 134S being sent from the joystick 134 to direct swinging movement of the main frame 32 and boom assembly 42. A position sensor 138 may detect a physical position of the operator input actuator 134 and generate a joystick position signal 138S monitored by controller 152, indicating to the controller 152 what position the joystick 134 is in within the control pattern shown in FIG. 10.

FIG. 7 schematically illustrates a second embodiment of a hydraulic control system 100B configured to implement the swing deceleration control system of the present disclosure. The hydraulic control system 100B is similar in most respects to the hydraulic control system 100A just described with regard to FIG. 6, and like components carry like numbers and their descriptions will not be repeated.

The hydraulic control system 100B further includes a bypass line 128 connecting the first and second fluid supply lines 108 and 110 and thereby communicating the first and second pressure ports 104 and 106 of hydraulic motor 40. An adjustable control valve 130 is disposed in the bypass line 128. The adjustable control valve 130 may be embodied as a type of valve sometimes referred to as an electronic cushion valve. The adjustable control valve 130 includes an adjustable size orifice 132 schematically shown in FIG. 7. The adjustable control valve 130 is an electro-hydraulic control valve and it is connected to the controller 152 described below to received command signals from the controller to control the size of the adjustable size orifice 132.

### THE CONTROL SYSTEM OF FIG. 8

As schematically illustrated in FIG. 8, the working machine 20 includes a control system 150 including a controller 152. The controller 152 may be part of the machine control system of the working machine 20, or it may be a separate control module. The controller 152 may be mounted in the operators cab 60 at the control panel 62. The controller 152 is configured to receive as input signals the pivot angle signal 76S from the pivot angle sensor 76, the motor speed signals 78S and 80S from the motor speed sensors 78 and 80, and the swinging motion signal 82S from the any one or more of the swinging motion sensors 82. The signals transmitted from the various sensors to the controller 152 are schematically indicated in FIG. 8 by phantom lines connecting the sensors to the controller with an arrowhead indicating the flow of the signal from the sensor to the controller 152.

Similarly, the controller 152 will generate control signals for controlling the operation of the various actuators, which control signals are indicated schematically in FIG. 8 by phantom lines connecting the controller 152 to the various actuators with the arrow indicating the flow of the command signal from the controller 152 to the respective actuator. It will be understood that the various actuators as disclosed herein may be hydraulic motors or may be hydraulic piston-cylinder units and that the electronic control signals from the controller 152 will actually be received by electro-hydraulic control valves associated with the actuators and the electro-hydraulic control valves will control the flow of hydraulic fluid to and from the respective hydraulic actuators to control the actuation thereof in response to the control signal from the controller 152.

The control signals 40C (see FIG. 8) sent to the electro-hydraulic directional control valve 102 to control the swing motor 40 selectively drive the swing motor 40 to automatically rotate the main frame 32 about the pivot axis 36 relative to the undercarriage 22 in response to various ones of the input signals from sensors 82. Control signals 28C and 30C (see FIG. 8), which may be referred to as first and second travel motor speed signals, sent to the first and second travel motors 28 and 30 control a direction and speed of the first and second travel motors 28 and 30.

Controller 152 includes or may be associated with a processor 154, a computer readable medium 156, a data base 158 and an input/output module or control panel 160 having a display 162. An input/output device 164, such as a keyboard, joystick or other user interface, is provided so that the human operator may input instructions to the controller. The input/output device 164 may include the previously described operator input actuator 134 in the form of a joystick. It is understood that the controller 152 described herein may be a single controller having all of the described functionality, or it may include multiple controllers wherein the described functionality is distributed among the multiple controllers.

Various operations, steps or algorithms as described in connection with the controller 152 can be embodied directly in hardware, in a computer program product 166 such as a software module executed by the processor 154, or in a combination of the two. The computer program product 166 can reside in RAM memory, flash memory, ROM memory, EPROM memory, EEPROM memory, registers, hard disk, a removable disk, or any other form of computer-readable medium 156 known in the art. An exemplary computer-readable medium 156 can be coupled to the processor 154 such that the processor can read information from, and write information to, the memory/ storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

In FIG. 8 portions of the hydraulic control systems 100 previously described with regard to FIGS. 6 and 7 are also illustrated, including the previously mentioned hydraulic pump 66 driven by the engine 64. Pump 66 takes hydraulic fluid from the tank 114 and provides pressurized hydraulic fluid to the hydraulic fluid supply line 109. As previously described, supply line 109 provides hydraulic fluid from the pump 66 to the electro-hydraulic directional control valve 102 to drive the swing motor 40. The working machine 20 of course may include many other hydraulic actuators which are not shown in FIG. 8. For example, supply line 109 may also be connected to a first inlet of each of two electro-hydraulic direction and flow rate control valves 28V and 30V associated with the first and second travel motors 28 and 30.

Each of the valves 28V and 30V is shown as a three position valve having a center position where there is no flow through the valve, a left side position wherein fluid flows to a first outlet port, and right side position wherein fluid flows to a second outlet port. The hydraulic fluid from each control valve flows to its respective hydraulic motor in the selected direction. Return fluid from the hydraulic motors flows back through the respective control valve to the return line 112 which returns the hydraulic fluid to tank 114.

### METHODS OF SWING DECELERATION CONTROL:

As noted above the present disclosure is directed to reducing the phenomena of “swing wag” due to the inertia of the moving main frame 32 and boom assembly 42 when the swinging action is stopped. When the joystick 134 or other actuator is returned to a neutral position 136 to stop the swinging motion, the kinetic energy of the swinging body including the main frame 32 and the boom assembly 42 is stored in a compression of the oil in the hydraulic system 100 which is then released causing the swinging body to swing back in the opposite direction.

The prior art technology for dealing with “swing wag” is the use of an anti-reaction valve which is a mechanical pressure relief valve which opens a passage communicating the pressure ports of the hydraulic motor driving the swinging action. This releases the potential energy stored in the compression of the oil in the hydraulic system, thus reducing the “swing wag.” But such anti-reaction valves do not work accurately over all deceleration profiles due to their fixed pressure relief settings and fixed orifice sizes.

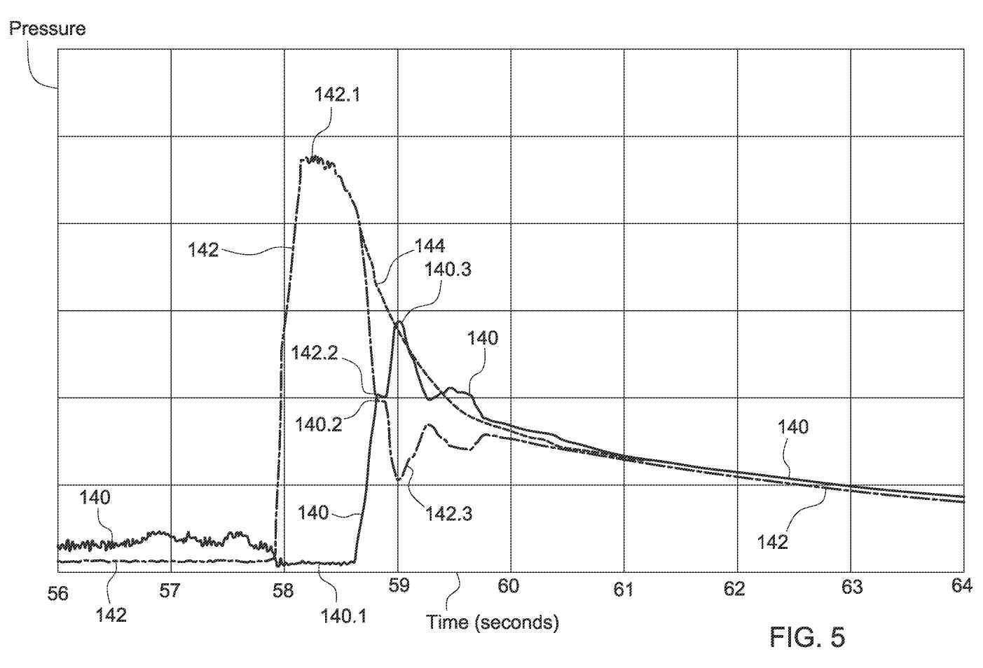

FIG. 5 schematically depicts the pressures at ports 104 and 106 for a prior art arrangement using a mechanical anti-reaction valve (see curves 140 and 142) and compares that to a desired swing deceleration curve 144 which may be achieved by the systems of the present disclosure. In the example of FIG. 5 curves 140 and 142 represent the pressures measured at ports 104 and 106 of the hydraulic motor 40 assuming that the high pressure was previously being directed to port 104 and that the control valve 102 is closed at approximately time “58” shown in FIG. 5. Due to the continuing pivotal motion of the main frame 32 and boom assembly 42 caused by the inertia of those large heavy structures, the pressure in what was the low pressure exit port 106 as shown in curve 142 almost immediately spikes to point 142.1 and the pressure in what was the high pressure port 104 drops slightly as indicated at point 140.1. If a prior art anti-reaction valve were used and were designed to relieve the pressure difference at point 142.1, then the pressure at port 106 would drop sharply and the pressure at port 104 would rise sharply until shortly before time “59” the curves cross at points 142.2 and 140.2. The main frame 32 and boom assembly 42 are actually swinging back in the opposite direction, but now there is a spike to point 140.3 at port 104, and the pressure at port 106 drops sharply to point 142.3. Then each curve 140 and 142 is seen to oscillate toward an equilibrium. This is the “wagging” back and forth of the boom assembly 42 that occurs using the prior art anti-reaction valve.

FIG. 5 schematically shows as curves 140 and 142 the pressure at the first and second ports 104 and 106 of the swing motor 40, if it was using a traditional anti-reaction valve. FIG. 5 also shows as a dashed curve 144 the desired swing deceleration profile which may be achieved with the systems of the present disclosure.

The present disclosure provides a control system which substantially reduces these pressure fluctuations, and which provides a much smoother deceleration of the moving body, i.e. the main frame 32 and boom assembly 42, so that the pressure surge on the downstream side of the motor (port 106 in this example) drops in a smooth curve such as 144 without or with reduced oscillation of the pressure curves of the two pressure ports 104 and 106. The pressure in the downstream port will still spike to a point like 142.1, but then instead of allowing the main frame 32 and boom assembly 42 to oscillate or “wag” back and forth, the present system will reduce the pressure in the downstream port in a smooth manner as represented by curve 144.

Using either the embodiment of FIG. 6 or that of FIG. 7, the controller 152 is operably connected to the operator input actuator 134 to receive the operator input signal 134S. The controller 152 is also operably connected to one or more of the swinging motion sensors 82 to receive one or more swinging motion signals 82S. As previously noted the swinging motion sensors 82 include pivot angle sensor 76, IMU 84, IMU 85 and GPS sensing units 86 and 88.

The controller 152 is configured, via appropriate programming of the software 166, to detect an inertial caused pivotal motion of the main frame 32 and the boom assembly 42 relative to the undercarriage 22 continuing after the operator input actuator 134 is moved to the neutral position 136, and to send a command signal to the adjustable control valve 102 (for the FIG. 6 embodiment) or 130 (for the FIG. 7 embodiment) to reduce the inertia caused pivotal motion.

In the embodiment of FIG. 6, the adjustable control valve 102 is a hydraulic fluid supply control valve 102 communicated with the first and second pressure ports 104 and 106 of the swing hydraulic motor 40 and configured to control the flow direction and the flow rate of hydraulic fluid from the hydraulic pressure source 66 to the swing hydraulic motor 40. The controller 152 is configured to send the command signal 40C to the hydraulic fluid supply control valve 102 to direct the hydraulic fluid supply control valve 102 to send the hydraulic fluid flow to one of the first and second pressure ports 104 or 106 to at least partially offset the detected inertia caused pivotal motion. For example, as pressure builds in either port 104 or 106 due to inertia of the machine, control valve 102 will be shifted to opposite port 102B or 102C to relieve pressure built between 104 and 106.

In the embodiment of FIG. 7, the adjustable control valve 130 includes an adjustable orifice valve 130 disposed in the bypass line 128 communicating the first and second pressure ports 104 and 106 of the swing hydraulic motor 40. The controller 152 is configured to send the command signal 130C to the adjustable orifice valve 130 to adjust a pressure restriction 132 between the first and second pressure ports 104 and 106 in the bypass line 128 to at least partially relieve a pressure differential between the first and second pressure ports 104 and 106 caused by the inertia caused pivotal motion. For example, as pressure builds in either port 104 or 106 due to inertia of the machine the orifice 132 will be controlled to a prescribed opening to eliminate the differential pressure between ports 104 and 106.

It is noted that in the embodiment of FIG. 6 the electro-hydraulic directional control valve 102 provides two functions. First the electro-hydraulic directional control valve 102 serves the primary function of controlling the flow of hydraulic fluid from pump 66 to motor 40 to control the direction and speed of the motor 40 when the operator input actuator 134 is directing a swinging or pivotal motion of the main frame 32 and boom assembly 42 about the pivot axis 36. Second, after the operator input actuator 134 is moved to the neutral position 136, and the electro-hydraulic directional control valve 102 is no longer being used to drive the motor 40, the electro-hydraulic directional control valve 102 under suitable configuration of the controller 152 may be used as an adjustable control valve to reduce the inertia caused pivotal motion.

In the embodiment of FIG. 7, where a separate adjustable control valve 130 in the form of the adjustable orifice valve 130 has been provided, the electro-hydraulic directional control valve 102 only serves the primary function of controlling the direction and speed of the motor 40. The adjustable orifice valve 130 is then used to reduce the inertia caused pivotal motion of the main frame 32 and boom assembly 42.

The controller 152 may be configured to detect the inertia caused pivotal motion of the main frame 32 and boom assembly 42 relative to the undercarriage 22 continuing after the operator input actuator 134 is moved to the neutral position 136 by: (1) detecting whether the operator input actuator 134 is in the neutral position 136; and (2) detecting whether the main frame 32 and boom assembly 42 are pivoting about the pivot axis 36 relative to the undercarriage 22.

There are at least two ways in which the controller 152 may be configured to detect whether the operator input actuator 134 is in the neutral position 136. The first way is for the controller to monitor the operator input signal 134S and detect whether the operator input actuator 134 is sending an operator input signal 134S directing pivotal movement of the main frame 32 and boom assembly 34 about the pivot axis 36 relative to the undercarriage 22. If there is no operator input signal 134S or if the operator input signal 134S is not directing pivotal movement, then the controller 152 may determine that the operator input actuator 134 is in the neutral position 136. The second way is for the controller 152 to monitor the physical position of the operator input actuator 134 using position sensor 138.

There are several ways in which the controller 152 may be configured to detect whether the main frame 32 and boom assembly 42 are pivoting about the pivot axis 36 relative to the undercarriage 22. Each configuration may utilize one or more of the motion detection sensors 82.

In one embodiment the controller 152 may be configured to monitor the pivot angle signal 76S generated by the pivot angle sensor 76 to directly detect the pivotal motion of the main frame 32 relative to the undercarriage 22.

In another embodiment the controller 152 may be configured to monitor output signals 84S and/or 85S from the IMU’s 84 and 85 mounted on the main frame 32 and the boom assembly 42, respectively. If the undercarriage 22 is known to be in a stationary position, then any motion detected by the IMU’s 84 and/or 85 may be attributed to the main frame 32 and the boom assembly 42.

In another embodiment the controller 152 may be configured to monitor the position signals 86S and 88S from the GPS sensing units 86 and 88, and again if the undercarriage 22 is known to be in a stationary position, then any motion detected by the GPS sensing units 86 and 88 may be attributed to the main frame 32 to which the GPS sensing units are attached via the operator’s cab 60.

One method of operating the working machine 20 may be described as including: detecting with one or more of the motion detection sensors 82 a pivotal movement of the main frame 32 and boom 42 about the pivot axis 36 relative to the undercarriage 22 and generating with the motion detection sensor 82 a swinging motion signal 82S representative of the pivotal movement of the main frame 32 and boom 42 about the pivot axis 36 relative to the undercarriage 22; receiving the operator input signal 134S and the swinging motion signal 82S with the automatic controller 152; detecting with the automatic controller 152 an inertia caused pivotal motion of the main frame 32 and boom 42 relative to the undercarriage 22 continuing after the operator input actuator 134 is moved to the neutral position 136; and sending a command signal 40C or 130C from the automatic controller to the adjustable control valve 102 or 130 to reduce the inertia caused pivotal motion.

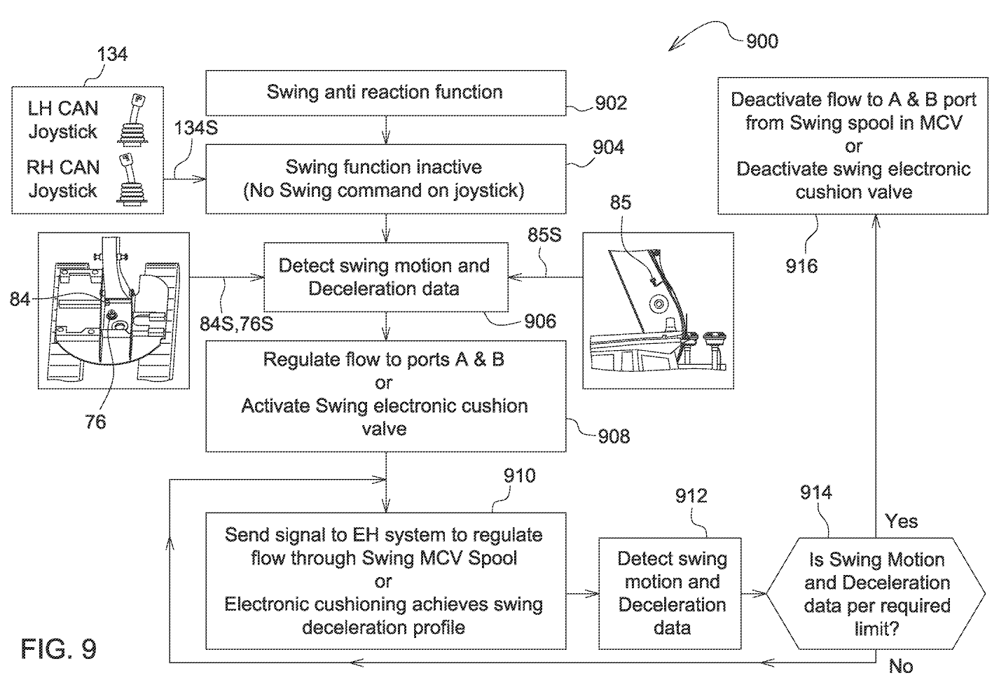

A further method of operating the working machine 20 is schematically illustrated in the flow chart of FIG. 9. Block 902 represents the activation of a swing anti-reaction function in the controller 152.

At block 904 it is determined whether the swing function of the system is active. In other words it is determined whether there is a swing command 134S coming from the joystick 134.

At block 906 the swing motion and deceleration data for the pivoting main frame 32 are determined by monitoring the various swinging motion sensors 82, such as IMU’s 84 and 85, and pivot angle sensor 76.

At block 908 the controller 152 determines whether there is an inertia caused pivotal motion of the main frame 32 and boom assembly 42 relative to the undercarriage 22 continuing after the operator input actuator 134 is moved to the neutral position 136. If such a condition is detected the controller 152 determines the necessary action of the control valve 102 or the control valve 130, depending on whether the embodiment of FIG. 6 or FIG. 7, respectively, is being used.

Next as shown at block 910 the controller 152 sends the appropriate command signal to the control valve 102 or the control valve 130, depending on whether the embodiment of FIG. 6 or FIG. 7, respectively, is being used.

At block 912 the controller continues to monitor the swinging motion and deceleration data for the main frame 32, using the various sensors as described above regarding block 906.

At block 914 the controller 152 determines whether the swing motion and deceleration data are within the desired limits to achieve the desired deceleration curve 144. If that condition is met, the anti-reaction function is terminated as indicated at block 916. If that condition is not met the controller 152 may continue to regulate the deceleration of the main frame 32.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1: A working machine, comprising:
an undercarriage including a plurality of ground engaging units for engaging a ground surface;
a main frame;
a swing hydraulic motor configured to pivot the main frame about a pivot axis relative to the undercarriage, the swing hydraulic motor including first and second pressure ports for receiving and discharging hydraulic fluid driving the swing hydraulic motor;
a boom assembly extending from the main frame;
an operator input actuator for generating an operator input signal directing pivotal movement of the main frame and boom assembly about the pivot axis relative to the undercarriage, the operator input actuator having a neutral position;
a motion detection sensor for detecting pivotal movement of the main frame and boom assembly about the pivot axis relative to the undercarriage and for generating a swinging motion signal representative of the pivotal movement of the main frame and boom assembly about the pivot axis relative to the undercarriage;
an adjustable control valve communicated with the first and second pressure ports of the swing hydraulic motor; and
a controller operably connected to the operator input actuator to receive the operator input signal and operably connected to the motion detection sensor to receive the swinging motion signal, the controller being configured to:
detect an inertia caused pivotal motion of the main frame and boom assembly relative to the undercarriage continuing after the operator input actuator is moved to the neutral position; and
send a command signal to the adjustable control valve to reduce the inertia caused pivotal motion.

2: The working machine of claim 1, wherein:
the motion detection sensor includes a pivot angle sensor configured to provide a pivot angle signal corresponding to a pivot position of the main frame relative to the undercarriage about the pivot axis.

3: The working machine of claim 2, wherein:
the motion detection sensor further includes an inertial measurement unit (IMU) mounted on the main frame or the boom assembly.

4: The working machine of claim 1, wherein:
the motion detection sensor includes an inertial measurement unit (IMU) mounted on the main frame or the boom assembly.

5: The working machine of claim 1, wherein:
the adjustable control valve is a hydraulic fluid supply control valve communicated with the first and second pressure ports of the swing hydraulic motor and configured to control a flow direction and a flow rate of hydraulic fluid from a hydraulic pressure source to the swing hydraulic motor.

6: The working machine of claim 5, wherein:
the controller is configured to send the command signal to the hydraulic fluid supply control valve to direct the hydraulic fluid supply control valve to send a hydraulic fluid flow to one of the first and second pressure ports to at least partially offset the detected inertia caused pivotal motion.

7: The working machine of claim 1, wherein:
the adjustable control valve includes an adjustable orifice valve disposed in a bypass line communicating the first and second pressure ports of the swing hydraulic motor.

8: The working machine of claim 7, wherein:
the controller is configured to send the command signal to the adjustable orifice valve to adjust a pressure restriction between the first and second pressure ports in the bypass line to at least partially relieve a pressure differential between the first and second pressure ports caused by the inertia caused pivotal motion.

9: The working machine of claim 1, wherein:
the pivot axis is substantially vertical when the ground surface engaged by the ground engaging units is substantially horizontal.

10: The working machine of claim 1, wherein:
the controller is configured to detect the inertia caused pivotal motion of the main frame and boom assembly relative to the undercarriage continuing after the operator input actuator is moved to the neutral position by:
detecting whether the operator input actuator is in the neutral position; and
detecting whether the main frame and boom assembly are pivoting about the pivot axis relative to the undercarriage.

11: The working machine of claim 10, wherein:
the controller is configured detect whether the operator input actuator is in the neutral position by detecting whether the operator input actuator is sending the operator input signal directing pivotal movement of the main frame and boom assembly about the pivot axis relative to the undercarriage.

12: The working machine of claim 10, wherein:
the controller is configured detect whether the operator input actuator is in the neutral position by monitoring a physical position of the operator input actuator.

13: The working machine of claim 1, further comprising:
a hydraulic pump for supplying pressurized hydraulic fluid to the swing hydraulic motor;
an electro-hydraulic directional control valve arranged to receive the pressurized hydraulic fluid from the hydraulic pump and to control a direction and flow rate of the pressurized hydraulic fluid to a selected one of the first and second pressure ports of the swing hydraulic motor; and
first and second fluid supply lines connecting the electro-hydraulic directional control valve to the first and second pressure ports, respectively.

14: The working machine of claim 13, wherein:
the electro-hydraulic directional control valve is also the adjustable control valve; and
the controller is configured to send the command signal to the electro-hydraulic directional control valve to direct the electro-hydraulic directional control valve to send the pressurized hydraulic fluid to one of the first and second pressure ports to at least partially offset the detected inertia caused pivotal motion.

15: The working machine of claim 13, further comprising:
a bypass line connecting the first and second fluid supply lines and thereby communicating the first and second pressure ports; and
wherein the adjustable control valve includes an adjustable orifice valve disposed in the bypass line.

16: The working machine of claim 15, wherein:
the controller is configured to send the command signal to the adjustable orifice valve to adjust a pressure restriction between the first and second pressure ports in the bypass line to at least partially relieve a pressure differential between the first and second pressure ports caused by the inertia caused pivotal motion.

17: A method of operating a working machine, the working machine including an undercarriage including a plurality of ground engaging units for engaging a ground surface, a main frame, a swing hydraulic motor configured to pivot the main frame about a pivot axis relative to the undercarriage, a boom assembly extending from the main frame, an operator input actuator for generating an operator input signal directing pivotal movement of the main frame and boom assembly about the pivot axis relative to the undercarriage, and an adjustable control valve communicated with first and second pressure ports of the swing hydraulic motor, the method comprising:
detecting with a motion detection sensor a pivotal movement of the main frame and boom assembly about the pivot axis relative to the undercarriage and generating with the motion detection sensor a swinging motion signal representative of the pivotal movement of the main frame and boom assembly about the pivot axis relative to the undercarriage;
receiving the operator input signal and the swinging motion signal with an automatic controller;
detecting with the automatic controller an inertia caused pivotal motion of the main frame and boom assembly relative to the undercarriage continuing after the operator input actuator is moved to a neutral position; and
sending a command signal from the automatic controller to the adjustable control valve to reduce the inertia caused pivotal motion.

18: The method of claim 17, wherein:
the adjustable control valve is a hydraulic fluid supply control valve communicated with the first and second pressure ports of the swing hydraulic motor and configured to control a flow direction and a flow rate of hydraulic fluid from a hydraulic pressure source to the swing hydraulic motor; and
the sending includes sending the command signal to the hydraulic fluid supply control valve to direct the hydraulic fluid supply control valve to send a hydraulic fluid flow to one of the first and second pressure ports to at least partially offset the detected inertia caused pivotal motion.

19: The method of claim 17, wherein:
the adjustable control valve includes an adjustable orifice valve disposed in a bypass line communicating the first and second pressure ports of the swing hydraulic motor; and
the sending includes sending the command signal to the adjustable orifice valve to adjust a pressure restriction between the first and second pressure ports in the bypass line to at least partially relieve a pressure differential between the first and second pressure ports caused by the inertia caused pivotal motion.

20: The method of claim 17, wherein:
the detecting includes determining whether the operator input signal is commanding a pivotal motion of the main frame and boom assembly relative to the undercarriage.
